(19) United States
(12) Patent Application Publication
(10) Pub. No.: US 2004/0129151 A1
(43) Pub. Date: Jul. 8, 2004

(54) Compression apparatus

(76) Inventor: Clifford D. Ash, Amesbury, MA (US)

Correspondence Address: MILLIPORE CORPORATION, 290 CONCORD ROAD, BILLERICA, MA, 01821, US

(21) Appl. No.: 10/445,473

(22) Filed: May 27, 2003

Related U.S. Application Data
(60) Provisional application No. 60/438,044, filed on Jan. 3, 2003.

(51) Int. Cl. B30B 7/00; B30B 1/02; B30B 1/10; B30B 1/18; B30B 1/24; B30B 1/26; B30B 1/30; B30B 1/32; B30B 1/40

(52) U.S. Cl. 100/233; 100/293

(57) ABSTRACT

A compression apparatus for applying a compression force to a stack of filter disks comprising a compression activator and a compression applicator is provided. The compression activator includes a sleeve mounted on a first rod element, a first locking means for locking said sleeve in an upper position on the rod, a second locking means for locking said sleeve on a lower position on the first rod element and a lever for applying a force on said sleeve to move the sleeve along said first rod element. The compression applicator includes a compressible spring mounted on a second rod element, a third locking means for locking the spring in a compressed position when the third locking means is in a lower position on said second rod element. The first rod element and the second rod element are attachable to each other and to a third rod element extending through centrally positioned holes in each of a stack of filter disks, A lever for applying a force and the spring are positioned to apply a compression force on the stack of filter disks when the second locking means is positioned on the lower position on the first rod element. The compression activator and said compression applicator are detachable from each other.

### BACKGROUND OF THE INVENTION

The invention relates to an apparatus for compressing a stack of filter disks, such as removable cell-type filters through which fluids are passed for filtration. More particularly, this invention relates to an apparatus that has a compression activator and a compression element for easily, safely and effectively compressing a stack of filter disks, such as removable cell-type filter cartridges during the use of the cartridge to filter a fluid.

Cell-type filter cartridges have long been known and have been increasingly used in a variety of filtration environments. These types of filter cartridges are typically fabricated from individual cells generally having two layers of filter media separated from each other. Liquid typically flows from the outside of the filter medium into the space between the layers of the filter media toward the central portion of the cell. A significant advantage of cell-type filter cartridges is that the surface area of filter material is quite large when compared to the total volume of an assembled cell-type filter cartridge.

Disposed between each filter medium is a separator which is typically formed in the shape of disks having ribs radially extending from the central aperture in a spoke-like pattern. In addition to separating the two layers of filter media, it provides for fluid flow from the filter media toward the central aperture of the filter media.

The separator disk conventionally has stiffening members formed at the central aperture of the cell which are attached to a plurality of separating ribs to provide a rigid, box-like structure sufficient to impart substantial cantilever strength to the ribs. Further, one of the stiffening disks is conventionally positioned proximate the ends of the separator ribs in order to act as a load bearing surface to prevent media intrusion of the filtering medium and to prevent blocking the area of the flow path with the filtered liquid. Accordingly, one distinct advantage in this type of separator is that during backwashing or reverse flow (i.e., fluid flow from the central aperture of the filter cell out toward the surface of the filter medium) damage to the filter media is minimized.

During filtration, the stack of filter disks is subjected to a compression force so that the central openings of each filter in the stack are sealed to prevent fluid bypass of the filters. This compressive force generally has been effected by a centrally positioned threaded rod that extends through the stack and a threaded nut that mates with the rod as well as a compression spring. This system applies pressure to the filter and maintains a constant seal on the filter stack during filtration. Hand tools are required to adjust the compression spring to a proper height setting. This arrangement is undesirable since the degree of compressive force from stack to stack is not accurately reproducible since the position of the nut on the rod varies. This, in turn, results in excessive compressive force being applied in order to assure a desired seal. When the compressive force is excessive, mechanical welding (galling) of the nut threads to the rod threads occurs, resulting in damage to the compression apparatus, particularly, the center threaded rod.

Accordingly, it would be desirable to provide an apparatus for compressing a stack of filter disks in a manner which reproduces a degree of compressive force from stack to stack. In addition, it would be desirable to provide such an apparatus which is useful regardless of the number of filter disks in the stack. Furthermore, it would be desirable to provide such an apparatus which avoids galling of the apparatus caused by applying excessive compressive force to a stack of filter disks.

### SUMMARY OF THE INVENTION

The present invention provides a two-component apparatus for applying a compressive force to a stack of filter disks. The two components comprise a compression activator and a compression applicator. The compression activator and compression applicator are mounted on a common rod which also extends through a centrally located opening in each of a stack of filter disks. The compressive applicator is spring loaded which, in a rest position has a spring in an expanded position. The compression applicator is positioned on the top filter disk in the stack and includes a top locking plate adapted to move freely along the length of the rod. When the spring is fully compressed, the top plate is locked directly on the rod with a locking shaft handle.

The compression activator is attached to the end of the rod and locked in place. It includes a sleeve assembly which fits over the rod and is adapted to slide along the length of the rod. A lever and link construction is attached to the sleeve so that a downward force or an upward force can be applied to the sleeve to move the sleeve along the length of the rod. When the sleeve is moved downward along the rod, it applies a compression force to the compression applicator which, in turn, applies a compression force to the stack of filters. After the compression application is fully compressed, it is fixed to the rod, and the compression activator is removed from the rod.

### BRIEF DESCRIPTION OF THE DRAWINGS

FIG. 1a is a side view of the compressive activator in a locked position.

FIG. 1b is a side view of the compression activator and compression applicator of this invention prior to applying compression force to a stack of filter disks.

FIG. 1c is a side view of the apparatus of this invention when rod elements of the compression activator and the compression applicator are locked.

FIG. 1d is a side view of the compression application and a compressed stack of filter disks suitable for use in a filter housing.

FIG. 1e is a side view of the compression applicator and compressed stack of disks.

FIG. 2 is a cross sectional view of the compressor applicator and compressed stack of filter disks in a filter housing.

FIG. 3 is a top view of the rod upon which the stack of filter disks is positioned.

FIG. 4 is a side view of the rod of FIG. 3.

FIG. 5 is a cross sectional view of the compression activator in a locked position.

### DESCRIPTION OF SPECIFIC EMBODIMENTS

The present invention comprises a compression activator which can be utilized sequentially with a plurality of compression applicators as well as a compression apparatus comprising a compression activator and a compression applicator, each mounted on a rod element configured so that the rod elements can be attached to each other and subsequently detached from each other. The rod elements are attached to each other when it is desired to apply a compression force to a stack of filter disks. The rod elements are detached after application of the compression force has been completed so that the compression activator can be removed and then attached to a second compression applicator for the same purpose.

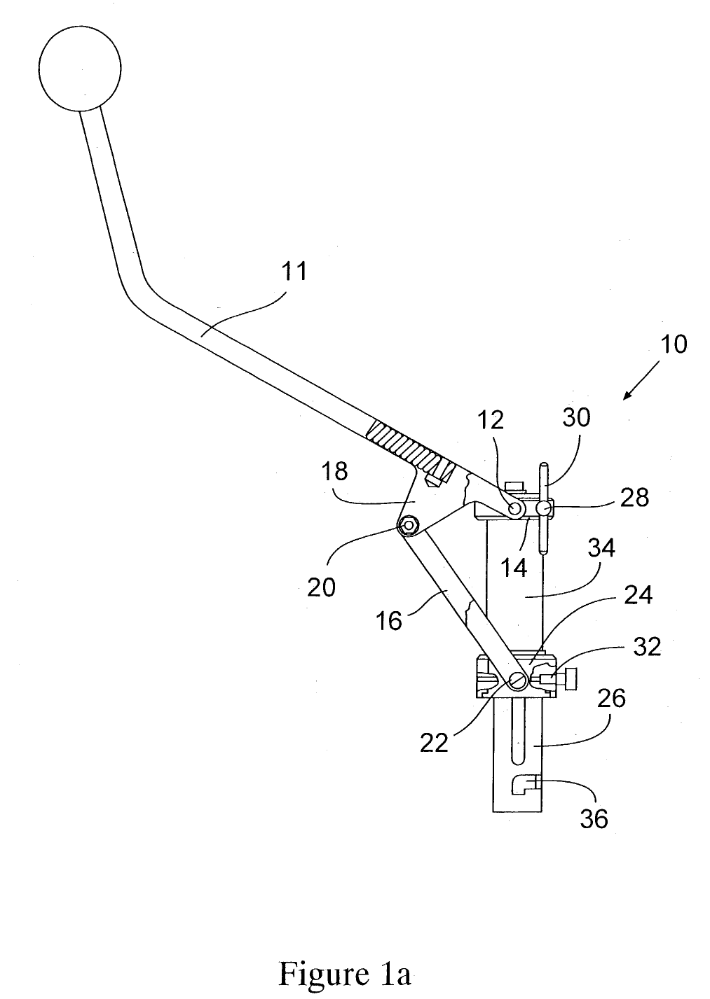

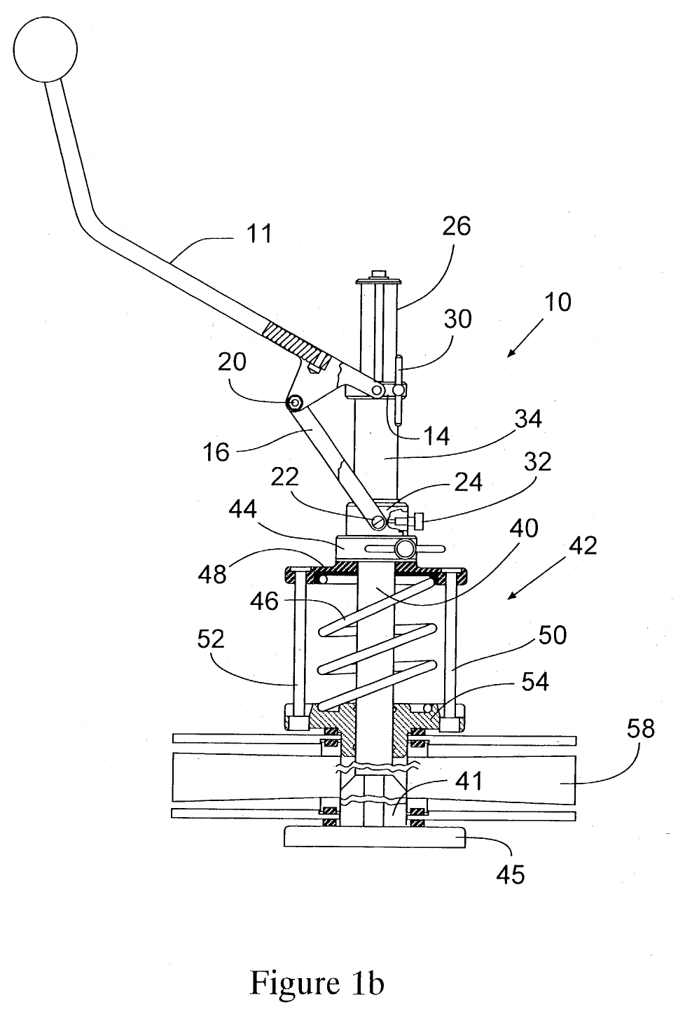

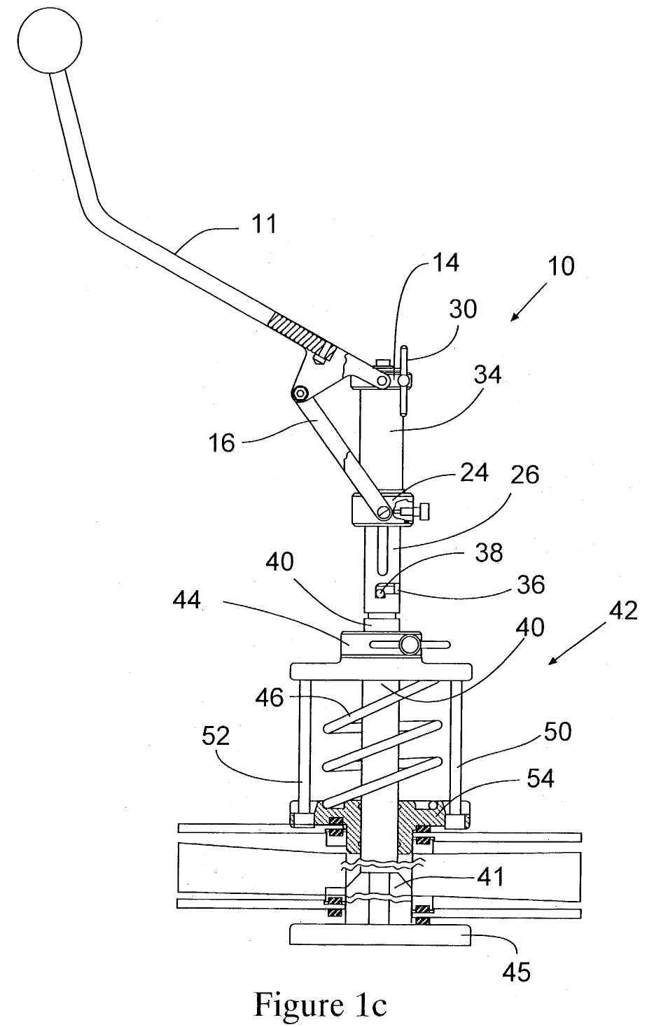

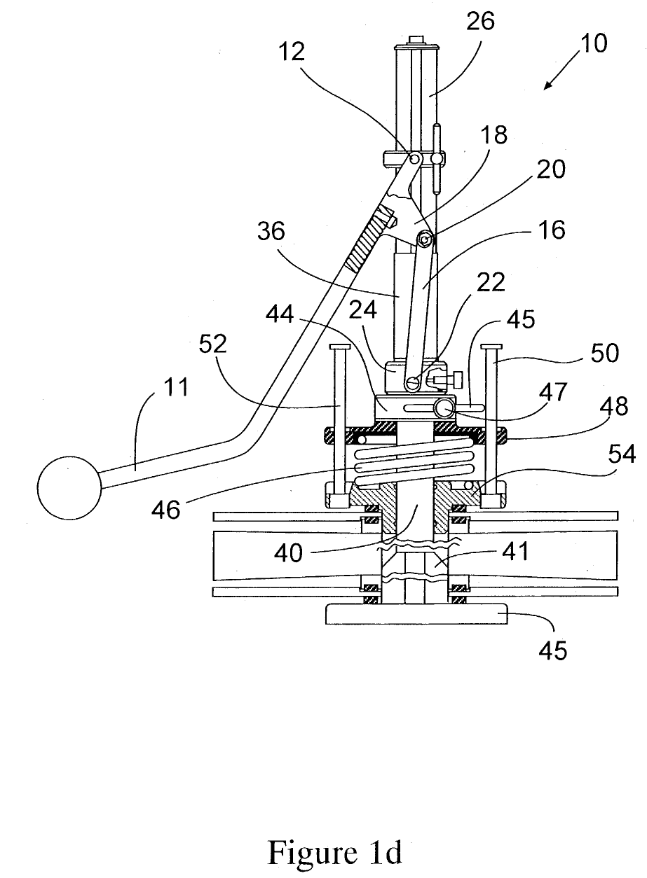

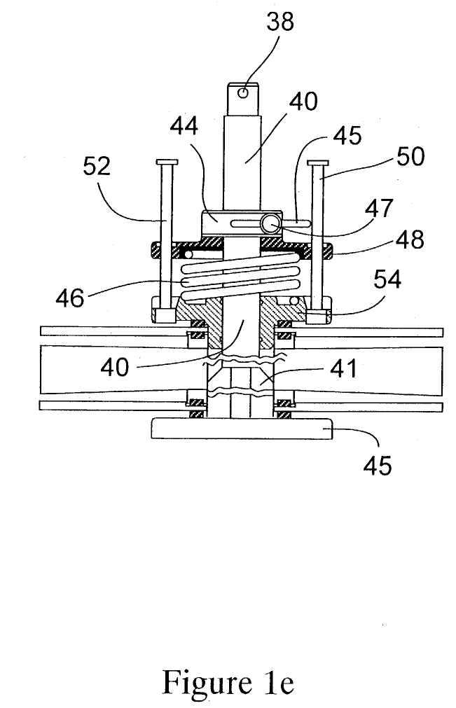

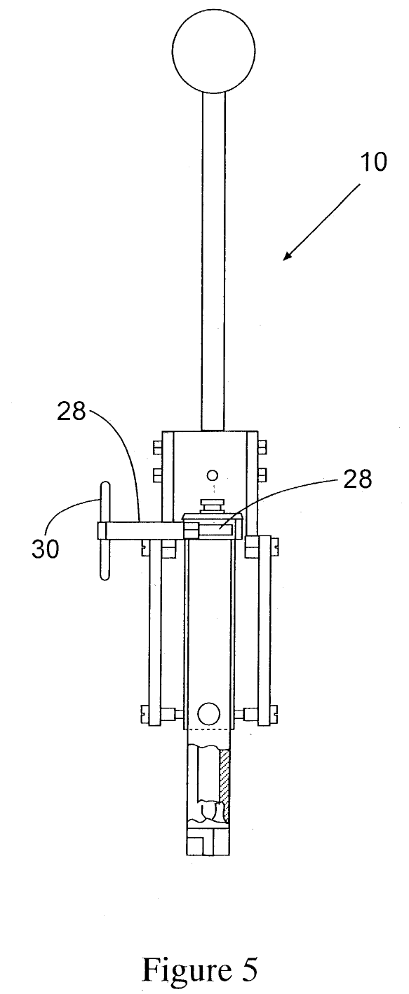

Referring to FIG. 1a, a compression activator 10 of this invention is shown in a locked position wherein the sleeve 34 is indirectly locked to the rod element 26. The compression activator 10 includes a lever 11, pivotally mounted on shaft 12, which, in turn, is connected to collar 14. A toggle link 16 is pivotally mounted on flange 18 at shaft 20. The toggle link 16 is also pivotally mounted on shaft 22 which, in turn, is fixed in collar 24. The collar 14 is a split collar which can be closed to lock it on rod element 26 or it can be opened by rotating top key 28 by application of force on handle 30. The top key 28 mates with threads in collar 28 (See FIG. 5). When the collar 14 is open and when spring loaded shaft 32 is pulled out from a mating slot (not shown) in the rod element 26, the collar 14 and 24 and sleeve 34 can be moved along the length of rod element 26.

Rod element 26 is provided with a keyway 36 into which can be fit a key 38 (FIG. 1b) so that rod element 26 can be attached to rod 40 of compression applicator 42 (FIG. 1c). The rod elements 26 and 40 can be detached from each other by pushing compression activator 11 downwardly toward rod element 40 and rotating it so that key 38 can be removed from keyway 36.

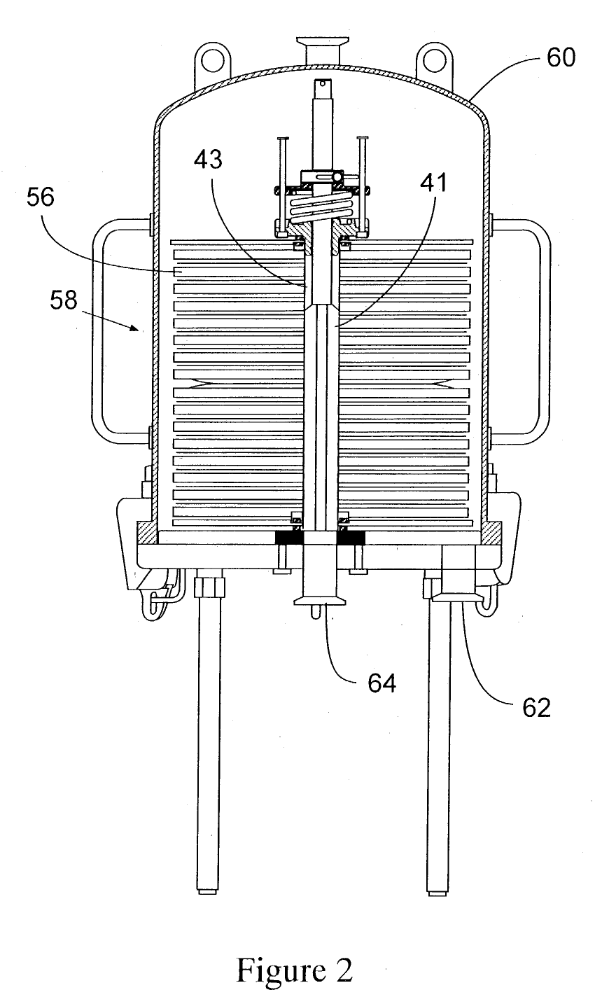

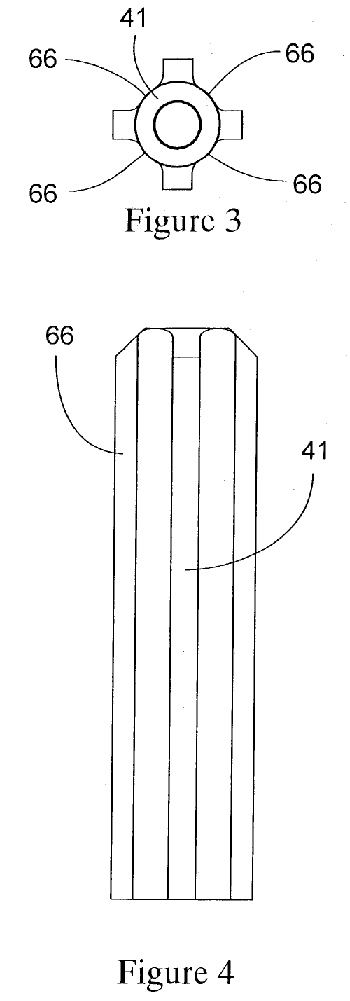

As shown in FIG. 1b, collar 14 has been opened by rotating handle 30 and spring loaded shaft 32 has been pulled away from rod element 26 so that collars 14 and 24 and sleeve 34 can be moved down rod element 26 so that collar 24 contacts collar 44. The locked position of compression activator 10 when collar 14 is closed is shown in FIG. 1c. Rod element 26 is positioned through central openings 43 of the stack 58 of filter disks (FIG. 2).

After collars 24 and 44 have been contacted, a downward force is applied to lever 11 so that a compression force is applied to spring 46 through plate 48. Plate 48 is mounted on guide shafts 50 and 52 which, in turn, are fixed to plate 54. Plate 54 contacts a plate top filter 56 (FIG. 2) of a stack of filter disks 58.

As shown in FIG. 1d, when the link 16 is positioned as shown, the plate 48 is in its lowermost position and, by virtue of its toggle construction will remain in this position until a reverse upward force is applied to lever 11. Collar 44 is locked on rod element 40 by turning threaded shaft 47 with bottom key 45 to tighten the split collar 44. By locking the collar 44, spring 46 is not free to expand so that it remains in the compressed position shown in FIGS. 1d and 1e. Compression activator 10 then is detached by rod element 40 by removing key 38 from keyway 36.

As shown in FIG. 2, the compressed stack of filter disks 58 is positioned within filter housing 60 having a fluid inlet 62 and a fluid outlet 64. Incoming fluid passed through the stack of filtration disks 58 and down the openings 66 of rod element 41 (FIGS. 4 and 5) and then through outlet 64. Upon completion of filtration, the used stack of filter disks 58 is removed from the housing 60. The compression activator 10 then is connected to rod element 40. Shaft 47 is loosened to open collar 44 and the spring 46 is gradually expanded using lever 11, then removing activator 10 to permit removal of the stack of filter disks 58 from the rod element 41 to be replaced by a fresh stack of filter disks.

The compression activator 10 of this invention is utilized as follows:

After the filter disks 58 are positioned on the rod element 40 and the top plate 56 is in place, install the compression activator 42 on top of the plate 56. Push the compression activator 42 down flush with the surface of the top plate 56. Place the compression spring 46 over the center post 40 and position it to rest in a groove (not shown) on top of the top plate 56. After making sure the bottom key 45 is loose, clamp collar 44 is placed over the spring 46 and slots in the collar 44 are aligned with the rods 50 and 52.

### TO COMPRESS

Place the compression activator 10 onto the center post 40. Push down and turn so that the spring loaded shaft 32 on the center post 40 is engaged in a slot (not shown) on the center post 40. Loosen the top key 28 with handle 30. Pull out on the spring loaded shaft 32 and move the collar 24 down so that it touches the surface of the collar 44 and the lever 11 us in a fully raised position. Tighten the top key 28, then push down on the lever 11, compressing spring 46. Tighten the bottom key 45. Raise the lever 11, to the upright position, then loosen the top key 28 and remove the compression activator 10 by pulling up on the collar 24 until the spring loaded shaft 32 is engaged in the sleeve 34. When the spring loaded shaft 32 is engaged in the sleeve 34, collar 24 will stay up. Push down on the top of the compression activator 10 slightly to disengage the spring loaded shaft 32 from the slot and rotate ¼ turn to remove the compression activator 10 from the center post 40.

### TO DECOMPRESS

Place the compression activator 10 onto the center post 40. Push down and turn the compression activator 10 so that a spring loaded shaft 32 is engaged in a slot (not shown) on the center post 40. Pull out the spring loaded shaft 32 and move the collar 24 down so that it touches the surface of the collar 44 and the toggle link 16 is perpendicular to the surface of the top plat 56 and the toggle link 16 is fully lowered. Tighten the top key 28 with handle 30. Loosen the bottom key 45 while firmly pressing down on the toggle link 16. Raise the toggle link 16 to the upright position, then loosen the top key 28 and remove the compression activator 10 by pulling up on the collar 24 until the spring loaded shaft 32 engages in the sleeve 34. When the spring loaded shaft 32 is engaged in the sleeve 34, the collar 24 will stay up. Push down on the top of the compression activator 10 slightly to disengage the spring loaded shaft 32 from the slot and rotate ¼ turn to remove the compression activator 10 from the center post 40.

1. A compression apparatus for applying a compression force to a stack of filter disks which comprises:
a compression activator comprising a sleeve mounted on a first rod element, a first locking means for locking said sleeve in an upper position on said rod, a second locking means for locking said sleeve on a lower position on said first rod element and means for applying a force on said sleeve to move said sleeve along said first rod element,
and a compression applicator comprising a compressible spring mounted on a second rod element, a third locking means for locking said spring in a compressed position when said third locking means is in a lower position on said second rod element,
said first rod element and said second rod element being attachable to each other and to a third rod element extending through centrally positioned holes in each of a stack of filter disks,
said means for applying a force and said spring being positioned to apply a compression force on said stack of filter disks when said second locking means is positioned on said lower position on said first rod element,
said compression activator and said compression applicator being detachable from each other.

2. The compressor apparatus of claim 1 wherein said means for applying a force comprising a handle connected to a toggle lever.

3. A compression activator comprising a sleeve mounted on a first rod element, a first locking means for locking said sleeve in an upper position on said rod, a second locking means for locking said sleeve on a lower position on said first rod element and means for applying a force on said sleeve to move said sleeve along said first rod element.

4. The compressor apparatus of claim 3 wherein said means for applying a force comprising a handle connected to a toggle lever.
